(19) United States
(12) Patent Application Publication
(10) Pub. No.: US 2026/0330305 A1
(43) Pub. Date: Oct. 22, 2026

(54) INFORMATION PROCESSING DEVICE, INFORMATION PROCESSING METHOD, AND NON-TRANSITORY COMPUTER READABLE MEDIUM

(71) Applicant: NEC Corporation, Tokyo (JP)

(72) Inventors: Taro YANO, Tokyo (JP); Yoichi ISHIBASHI, Tokyo (JP); Masafumi OYAMADA, Tokyo (JP)

(73) Assignee: NEC Corporation, Tokyo (JP)

(21) Appl. No.: 19/467,997

(22) Filed: Feb. 3, 2026

(30) Foreign Application Priority Data
Feb. 14, 2025 (JP) 2025-022624

(51) Int. Cl. G06N 20/00; G06F 40/40

(52) U.S. Cl. CPC G06N 20/00; G06F 40/40

(57) ABSTRACT

An information processing device includes an acquisition unit acquiring one or more models, a selection unit selecting any action from among a plurality of candidate actions each defining a model improvement method, and a generation unit generating an improved model from the one or more models by executing a selected action. The information processing apparatus further enables automated and reliable decision making in diverse artificial intelligence applications by continually improving model performance.

### INCORPORATION BY REFERENCE

This application is based upon and claims the benefit of priority from Japanese patent application No. 2025-022624, filed on Feb. 14, 2025, the disclosure of which is incorporated herein in its entirety by reference.

### TECHNICAL FIELD

The present disclosure relates to an information processing device, an information processing method, and an information processing program.

### BACKGROUND ART

Techniques for autonomous improvement of models such as LLM (Large Language Models) are known. As an example of a technique of self-improvement of LLM, for example, a technique described in Self-Rewarding Language Models (Weizhe Yuan et al., Self-Rewarding Language Models, 2024) can be cited.

### SUMMARY

In the technique described in Self-Rewarding Language Models (Weizhe Yuan et al., 2024), there is a problem that the performance of the model may not be improved in a case where improvement of the model is repeated.

The present disclosure has been made in view of the above problems, and an example object thereof is to provide a technique capable of further improving performance of a model in autonomous learning of the model.

An information processing device according to an example aspect of the present disclosure includes an acquisition means for acquiring one or more models, a selection means for selecting any action from among a plurality of candidate actions each defining a model improvement method, and a generation means for generating an improved model from the one or more models by executing a selected action.

An information processing method according to an example aspect of the present disclosure includes acquisition processing of acquiring, by at least one processor, one or more models, selection processing of selecting, by the at least one processor, any action from among a plurality of candidate actions each defining a model improvement method, and generation processing of generating, by the at least one processor, an improved model from the one or more models by executing a selected action.

An information processing program according to an example aspect of the present disclosure is a program for causing a computer to function as an information processing device, the information processing program causing the computer to execute an acquisition means for acquiring one or more models, a selection means for selecting any action from among a plurality of candidate actions each defining a model improvement method, and a generation means for generating an improved model from the one or more models by executing a selected action.

According to an example aspect of the present disclosure, there is an exemplary effect that it is possible to provide a technology capable of further improving performance of a model in autonomous learning of the model.

### BRIEF DESCRIPTION OF THE DRAWINGS

FIG. 1 is a block diagram illustrating a configuration of an information processing device according to the present disclosure;

FIG. 2 is a flowchart illustrating a flow of an information processing method according to the present disclosure;

FIG. 3 is a block diagram illustrating a configuration of an information processing device according to the present disclosure;

FIG. 4 is a diagram illustrating an example of a functional configuration of the information processing device according to the present disclosure;

FIG. 5 is a flowchart illustrating a flow of the information processing method according to the present disclosure; and

FIG. 6 is a block diagram illustrating a configuration of a computer functioning as the information processing device according to the present disclosure.

### EXAMPLE EMBODIMENT

Hereinafter, example embodiments of the present invention will be exemplified. However, the present invention is not limited to the following exemplary example embodiments, and various modifications can be made within a scope described in the claims. For example, example embodiments obtained by appropriately combining techniques (some or all of objects or methods) adopted in the following exemplary example embodiments can also be included in the scope of the present invention. Example embodiments obtained by appropriately omitting some of the techniques adopted in the following exemplary example embodiments can also be included in the scope of the present invention. Effects mentioned in the following exemplary example embodiments are examples of effects expected in the exemplary example embodiments, and do not define extension of the present invention. That is, example embodiments that do not provide the effects mentioned in each of the exemplary example embodiments described below can also be included in the scope of the present invention.

### First Exemplary Example Embodiment

A first exemplary example embodiment that is an example of the example embodiments of the present invention will be described in detail with reference to the drawings. The present exemplary example embodiment is a basic form of each exemplary example embodiment to be described below. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Each technique illustrated in the drawings referred to for describing the present exemplary example embodiment can also be adopted in another exemplary example embodiment included in the present disclosure within a range in which no particular technical problem occurs.

### Configuration of Information Processing Device

A configuration of an information processing device 1 will be described with reference to FIG. 1. FIG. 1 is a block diagram illustrating the configuration of the information processing device 1. As illustrated in FIG. 1, the information processing device 1 includes an acquisition unit 11, a selection unit 12, and a generation unit 13. The acquisition unit 11 acquires one or more models. The selection unit 12 selects any action from among a plurality of candidate actions each defining a model improvement method. The generation unit 13 generates an improved model from the one or more models by executing the action selected by the selection unit 12.

### Effects of Information Processing Device

As described above, the information processing device 1 employs a configuration including the acquisition unit 11 that acquires one or more models, the selection unit 12 that selects any action from among a plurality of candidate actions each defining a model improvement method, and the generation unit 13 that generates an improved model from the one or more models by executing the selected action. Therefore, according to the information processing device 1, it is possible to obtain an effect of further improving the performance of the model in the autonomous learning of the model.

### Flow of Information Processing Method

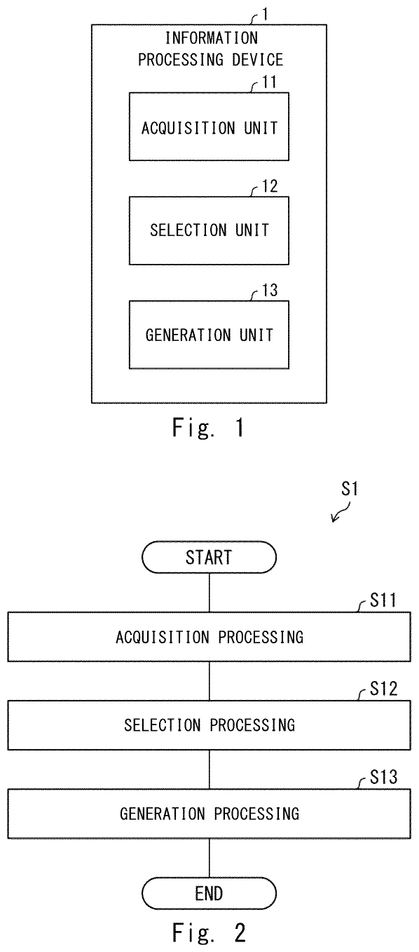

A flow of an information processing method S1 will be described with reference to FIG. 2. FIG. 2 is a flowchart illustrating a flow of the information processing method S1. As illustrated in FIG. 2, the information processing method S1 includes acquisition processing S11, selection processing S12, and a generation processing S13. In the acquisition processing S11, at least one processor acquires one or more models. In the selection processing S12, the at least one processor selects any action from a plurality of candidate actions each defining a model improvement method. In the generation processing S13, the at least one processor executes the selected action to generate the improved model from the one or more models.

### Effects of Information Processing Method

As described above, the information processing method S1 includes acquisition processing S11 in which at least one processor acquires one or more models, selection processing S12 in which the at least one processor selects any action from among a plurality of candidate actions each of which defines a model improvement method, and generation processing S13 in which the at least one processor generates an improved model from the one or more models by executing the selected action. Therefore, according to the information processing method S1, it is possible to obtain an effect that the performance of the model can be further improved in the autonomous learning of the model.

### Second Exemplary Example Embodiment

A second exemplary example embodiment that is an example of the example embodiments of the present invention will be described in detail with reference to the drawings. Components having the same functions as the components described in the above-described exemplary example embodiment are denoted by the same reference signs, and the description thereof will be appropriately omitted. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Each technique illustrated in the drawings referred to for describing the present exemplary example embodiment may also be adopted in another exemplary example embodiment included in the present disclosure within a range in which no particular technical problem occurs.

### Outline of Information Processing Device

An information processing device 1A is a device that implements autonomous learning of a model. Examples of the model include, but are not limited to, a neural network, a decision tree model, and the like. The model may be, for example, a language model such as LLM.

The information processing device 1A selects one of a plurality of candidate actions and executes the selected action to generate an improved model from one or more models. The action is a measure for improving the model. The action includes, for example, an action type and input data. The action type is information indicating the type of action, and indicates, as an example, a learning method (fine-tuning, etc.), a type of a loss function, a model merge method, and the like. Examples of the action type include “Supervised Fine-Tuning” and “TIES Merging”.

The input data is an input to an action, and differs depending on an action type. For example, in a case where the action type is “Supervised Fine-Tuning”, the input includes, as an example, a base model, training data, and a hyperparameter. For example, in a case where the action type is “TIES Merging”, the input includes, as an example, a first model, a second model, and a hyperparameter.

### Configuration of Information Processing Device

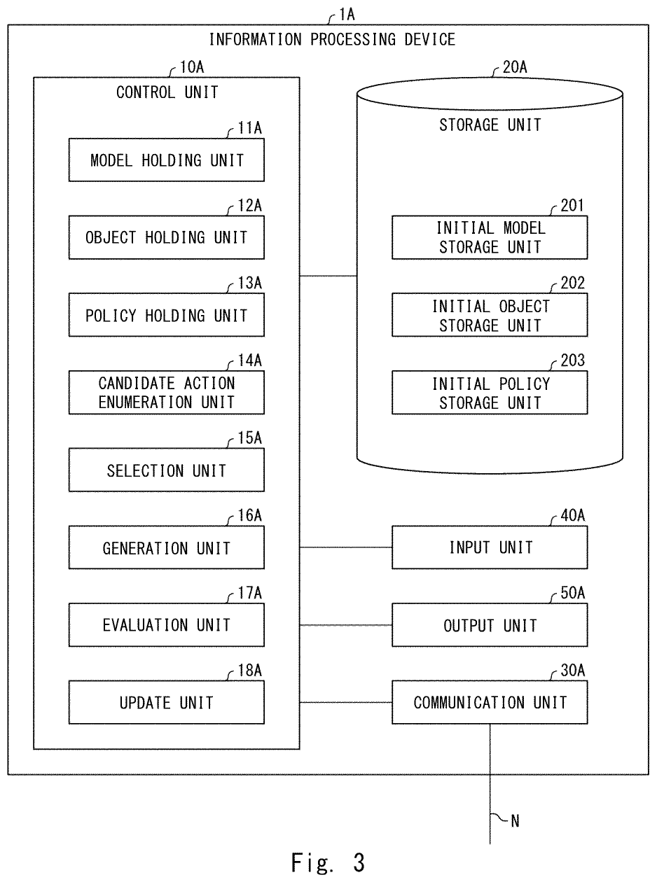

Next, a configuration of the information processing device 1A will be described with reference to FIG. 3. FIG. 3 is a block diagram illustrating a configuration of the information processing device 1A. The information processing device 1A includes a control unit 10A, a storage unit 20A, a communication unit 30A, an input unit 40A, and an output unit 50A.

### Communication Unit

The communication unit 30A communicates with a device outside the information processing device 1A via a communication line N. Although the specific configuration of the communication line N is not limited to the present exemplary example embodiment, the communication line N is, for example, a wireless local area network (LAN), a wired LAN, or a wide area network (WAN), a public network, a mobile data communication network, or a combination thereof. The communication unit 30A transmits data supplied from the control unit 10A to another device, and supplies data received from another device to the control unit 10A.

### Input Unit

The input unit 40A is a configuration for receiving an input to the information processing device 1A, and includes, as an example, an input device such as a keyboard, a mouse, a touch panel, a camera, or a microphone. The input unit 40A may be configured to receive data from the input device via, for example, an interface such as a universal serial bus (USB).

### Output Unit

The output unit 50A is a configuration for performing output from the information processing device 1A, and includes, as an example, an output device such as a display, a printer, a touch panel, or a speaker. The output unit 50A may include, for example, an interface such as a USB, and may be configured to output data to the output device via the interface.

### Storage Unit

The storage unit 20A stores various pieces of information referred to by the control unit 10A. In particular, the storage unit 20A includes an initial model storage unit 201, an initial object storage unit 202, and an initial policy storage unit 203. The initial model storage unit 201 stores one or more models. The one or more models include, as an example, a language model. The initial object storage unit 202 stores an object. The object is data used for executing an action to be described later, and includes training data, hyperparameters, and the like as an example.

The initial policy storage unit 203 stores policies. The policy is referred to in a case where a selection unit 15A to be described later selects an action from candidate actions. The policy takes multiple candidate actions as inputs and outputs a single action. As an example, the policy may include a learned language model.

In a case where the policy includes a language model, as an example, an action is expressed by text such as “TIES Merging using {model M1} and {model M2}”, and the text “Select optimum action from {action A1}, {action A2}, . . . {action Ak}” is used as a prompt to input into the language model. In other words, in a case where the policy includes a language model, each of the plurality of candidate actions is expressed by a text, and the selection unit 15A to be described later inputs a prompt for instructing to select one of the plurality of candidate actions to the language model to select an action.

The policy may include a hypothesis. As an example, the hypothesis is a text such as “Supervised Fine-Tuning is valid” or a text such as “The order of Supervised Fine-Tuning and TIES Merging is valid”.

The policy is not limited to the language model. The policy may be, for example, selecting any action according to a predetermined rule. More specifically, the policy may be, for example, selecting a plurality of candidate actions in a predetermined order, or randomly selecting one of the plurality of candidate actions. The policy may be to select an action with reference to an evaluation value for each action included in an evaluation result of an evaluation unit 17A described later.

### Control Unit

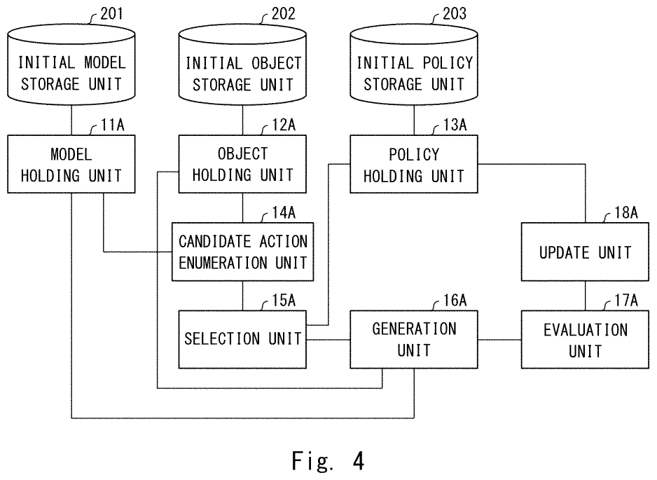

FIG. 4 is a diagram illustrating an example of a functional configuration of the control unit 10A. The control unit 10A includes a model holding unit 11A, an object holding unit 12A, a policy holding unit 13A, a candidate action enumeration unit 14A, a selection unit 15A, a generation unit 16A, an evaluation unit 17A, and an update unit 18A. The model holding unit 11A, the selection unit 15A, the generation unit 16A, the evaluation unit 17A, and the update unit 18A are examples of an acquisition means, a selection means, a generation means, an evaluation means, and an update means according to the present disclosure.

### Model Holding Unit, Object Holding Unit, Policy Holding Unit

The model holding unit 11A acquires one or more models stored in the initial model storage unit 201. The one or more models include, as an example, a language model. Here, “acquiring a model” includes acquiring information specifying the model. It is not necessary to acquire all of the plurality of parameters defining the model as long as a model to be improved can be specified. The object holding unit 12A acquires the object stored in the initial object storage unit 202. The policy holding unit 13A acquires the policy stored in the initial policy storage unit 203.

### Candidate Action Enumeration Unit

The candidate action enumeration unit 14A enumerates candidate actions from a combination of a model held by the model holding unit 11A and an object held by the object holding unit 12A. The candidate action is a measure that defines a model improvement method. As an example, the candidate action enumeration unit 14A refers to a table in which an action type, an object necessary for the action type, and a type of the model are described, and enumerates all possible combinations of objects and models from the model held by the model holding unit 11A and the object held by the object holding unit 12A, thereby setting the combinations as candidate actions. However, the method of enumerating the candidate actions is not limited to the above-described example.

### Selection Unit

The selection unit 15A selects one of a plurality of candidate actions enumerated by the candidate action enumeration unit 14A.

### First Example of Action Selection Processing

As an example, the selection unit 15A selects any one of the plurality of candidate actions with reference to a policy or information obtained by the policy. In a case where the learned language model is included in the policy, the selection unit 15A selects any action from the plurality of candidate actions with reference to the output of the language model as an example.

In a case where the policy includes a hypothesis, the selection unit 15A may select an action based on the hypothesis, as an example. The hypothesis may be acquired using a language model.

### Second Example of Action Selection Processing

As an example, the selection unit 15A may select any action from among a plurality of candidate actions according to a predetermined rule. More specifically, as an example, the selection unit 15A may select a plurality of candidate actions in a predetermined order, or may randomly select one of the plurality of candidate actions.

The policy may be to select an action with reference to an evaluation value for each action. In this case, as an example, the selection unit 15A selects an action with reference to an evaluation value for each action by the evaluation unit 17A described later. Here, as an example, the evaluation value may be a value included in an evaluation result by the evaluation unit 17A to be described later, or may be an accumulated value of evaluation values for each action by the evaluation unit 17A. As an example, the selection unit 15A may select an action having the highest evaluation value from among a plurality of candidate actions.

### Generation Unit

The generation unit 16A generates an improved model from the one or more models by executing the action selected by the selection unit 15A. The generation unit 16A adds the improved model and the improved object to the model holding unit 11A and the object holding unit 12A. As an example, the action executed by the generation unit 16A includes processing of merging the one or more models.

The action executed by the generation unit 16A includes, as an example, data generation and fine tuning. In other words, the action executed by the generation unit 16A can include, as an example, processing of generating data using at least one model by inputting a prompt to the at least one of the one or more models, and processing of updating at least one of the one or more models with reference to the generated data. Here, the processing of updating the model is processing of learning the model.

### Evaluation Unit

The evaluation unit 17A evaluates the improved model generated by the generation unit 16A. As an example, the evaluation unit 17A evaluates the performance of the improved model with a benchmark prepared in advance. The evaluation result by the evaluation unit 17A includes, as an example, a reward according to at least one of an index indicating the accuracy of the improved model and a cost of calculation to generate the improved model. The reward is an index of the quality of the action. As an example, the reward may be a value indicating the accuracy of the improved model, or may be a monotonically increasing function for the accuracy or a monotonically decreasing function for the calculation cost. The reward may be, for example, specifically, a value obtained by dividing the accuracy by the calculation cost.

### Update Unit

The update unit 18A refers to the evaluation result by the evaluation unit 17A and updates the policy or the information referred to by the policy. The information that the policy refers to includes, as an example, a prompt that is an input to a language model included in the policy. Hereinafter, the policy updated by the update unit 18A is also referred to as a “policy model”.

As an example, the update unit 18A updates the policy or the information (memory) referred to by the policy by the reinforcement learning using the index of the quality of the action as a reward. In other words, it can also be said that the update unit 18A refers to the reward included in the evaluation result by the evaluation unit 17A and updates the policy or the information referred to by the policy. Any method can be applied as the reinforcement learning method. For example, the update unit 18A may update the policy by directly updating the parameter of the policy model, or may update information referred to by the policy instead of the policy itself. Examples of a method of directly updating the parameter of the policy model include Proximal Policy Optimization (PPO), Deep Q-Networks (DQN), and REINFORCE. As a method of updating the information referred to by the policy, for example, there is a Reflexion method of updating the memory.

### Flow of Information Processing Method

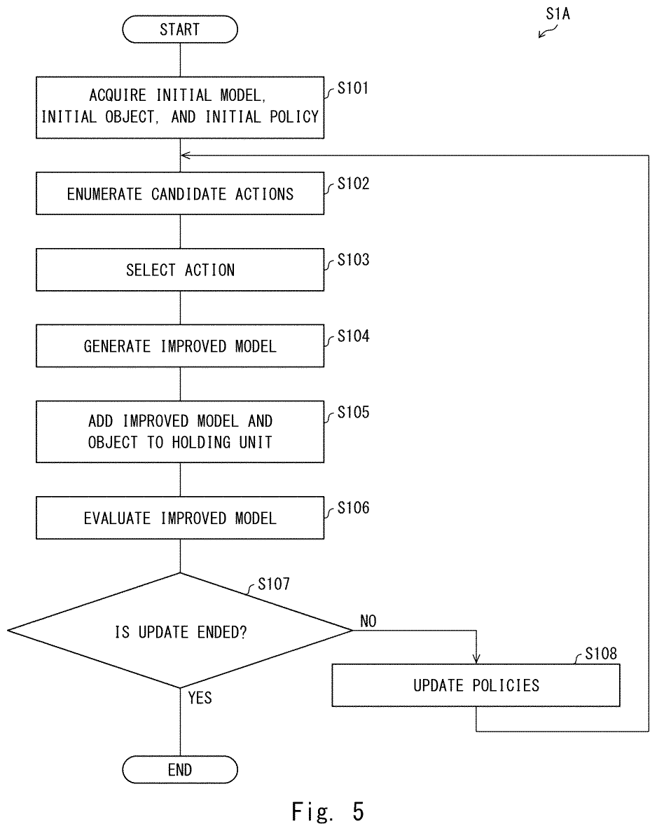

FIG. 5 is a flowchart illustrating the flow of the information processing method S1A. In step S101, the model holding unit 11A, the object holding unit 12A, and the policy holding unit 13A acquire an initial model, an initial object, and an initial policy. In step S102, the candidate action enumeration unit 14A enumerates a plurality of candidate actions using the model held by the model holding unit 11A and the object held by the object holding unit 12A.

In step S103, the selection unit 15A selects one of the plurality of candidate actions enumerated in step S102. In step S104, the generation unit 16A generates an improved model by executing the action selected by the selection unit 15A. In step S105, the generation unit 16A adds the improved model and the improved object to the model holding unit 11A and the object holding unit 12A.

In step S106, the evaluation unit 17A evaluates the improved model. In step S107, the update unit 18A determines whether to end the update. As an example, the update unit 18A determines to end the update in a case where the number of loops is equal to or more than a certain number of times or a desired evaluation result is obtained. The desired evaluation result may be, for example, that an index indicating the accuracy of the improved model satisfies a predetermined condition, or may be, for example, that the cost of calculation to generate the improved model satisfies a predetermined condition. In a case where the update is not ended (NO in step S107), the update unit 18A proceeds to the processing of step S108. On the other hand, in a case where the update is ended (YES in step S107), the update unit 18A ends the processing.

In step S108, the update unit 18A updates the policy. As an example, the update unit 18A updates the policy by reinforcement learning. In this case, as an example, the update unit 18A uses, as a reward, the accuracy of the model obtained as a result of the action, and causes learning of a policy so as to output an action with high accuracy and not to output an action with low accuracy.

In a case where the memory (the memory is from the past action-reward pair) used to create the prompt for selecting an action and the language model are used as policies, the update unit 18A may update the policies by updating the prompt, may update the policies by updating both the language model and the prompt, or may update the policies by updating the language model. In a case where the hypothesis is included in the memory, the update unit 18A may verify the hypothesis based on the evaluation result of the evaluation unit 17A and update the hypothesis based on the verification result.

The autonomous learning of the model is implemented by repeating the processing of steps S102 to S108.

### Application Example

The information processing device 1A can be applied to improvement of models used in various industries and business sectors. For example, the information processing device 1A can be used to support decision making regarding medical care of a medical worker such as a doctor in the medical field. In this case, as an example, the model to be improved may be a generative model that receives patient information or the like as inputs and outputs a discrimination result of the disease state of the patient. As another example, the model to be improved may be, as an example, a generative model that creates a summary and meeting minutes of a meeting using a text representing speech content of the meeting as an input.

### Effects of Information Processing Device

Meanwhile, in the development of a model such as LLM, research in which LLM autonomously improves LLM in order to reduce manual cost has attracted attention. However, for example, in the technology described in Self-Rewarding Language Models (Weizhe Yuan et al., 2024), since fixed model improvement measures are iteratively repeated, although performance is improved to some extent, performance may not be improved any more.

On the other hand, in the information processing device 1A, a configuration is adopted in which the selection unit 15A selects any action from the plurality of candidate actions with reference to a policy or information obtained by the policy. Therefore, according to the information processing device 1A, the performance of the model can be prevented from reaching a plateau in the autonomous learning of the model by executing an action selected with reference to a policy or information obtained by the policy instead of executing the action uniformly.

In the information processing device 1A, the policy includes a learned language model, and the selection unit 15A selects any action from the plurality of candidate actions with reference to the output of the language model. Therefore, according to the information processing device 1A, the autonomous learning of the model can be implemented using the learned language model.

The information processing device 1A employs a configuration in which the action executed by the generation unit 16A includes processing of generating data using the at least one model by inputting a prompt to at least one of the one or more models, and processing of updating at least one of the one or more models with reference to the generated data. Therefore, according to the information processing device 1A, by selecting any one of a plurality of candidate actions including fine tuning to generate an improved model, it is possible to further improve the performance of the model in autonomous learning of the model.

The information processing device 1A employs a configuration in which the action executed by the generation unit 16A includes processing of merging the one or more models. Therefore, according to the information processing device 1A, it is possible to further improve the performance of the model in the autonomous learning of the model by selecting one of the plurality of candidate actions including the processing of merging the model to generate the improved model.

In the information processing device 1A, a configuration in which a language model is included in the one or more models is adopted. Therefore, according to the information processing device 1A, it is possible to further improve the performance of the language model in the autonomous learning of the language model.

The information processing device 1A employs a configuration including an evaluation unit 17A that evaluates the improved model generated by the generation unit 16A, and an update unit 18A that refers to the evaluation result by the evaluation unit 17A and updates the policy or information referred to by the policy. Therefore, according to the information processing device 1A, it is possible to dynamically change the selected action by selecting the action according to a policy updated based on the evaluation result of the evaluation unit 17A, and thus, it is possible to further improve the performance of the model in the autonomous learning of the model.

In the information processing device 1A, the evaluation result by the evaluation unit 17A includes a reward according to at least one of (i) an index indicating the accuracy of the improved model and (ii) a cost of calculation to generate the improved model, and the update unit 18A refers to the reward and updates the policy or the information referred to by the policy. Therefore, according to the information processing device 1A, by referring to the reward included in the evaluation result and updating the policy or the information referred to by the policy, it is possible to further improve the performance of the model in the autonomous learning of the model.

### Exemplary Implementation by Software

Some or all of the functions of the information processing devices 1 and 1A (which will also be hereinafter referred to as “each of the above devices”) may be implemented by hardware such as an integrated circuit (IC chip), or may be implemented by software.

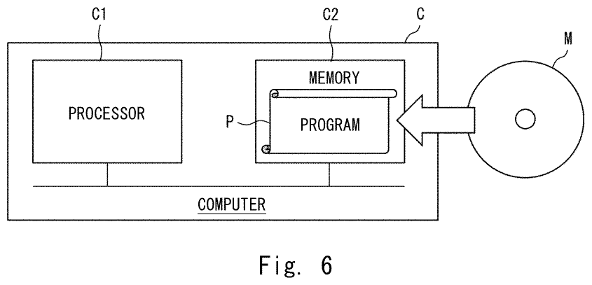

In the latter case, each of the above devices is achieved by, for example, a computer that executes commands of a program that is software for achieving each function. An example of such a computer (hereinafter referred to as a computer C) is illustrated in FIG. 6. FIG. 6 is a block diagram illustrating a hardware configuration of the computer C that functions as the above apparatuses.

The computer C includes at least one processor C1 and at least one memory C2. A program P for causing the computer C to operate as each of the above devices is recorded in the memory C2. In the computer C, by the processor C1 reading the program P from the memory C2 and executing the program P, each function of each of the above devices is achieved.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for developing the program P at the time of execution and temporarily storing various types of data. The computer C may further include a communication interface for transmitting and receiving data to and from another device. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

Each of the above functions of each of the above devices may be achieved by a single processor provided in a single computer, may be achieved in cooperation with a plurality of processors provided in a single computer, or may be achieved in cooperation with a plurality of processors provided in each of a plurality of computers. The program for causing each of the above devices to achieve each of the above functions may be stored in a single memory provided in a single computer, may be stored in a distributed manner in a plurality of memories provided in a single computer, or may be stored in a distributed manner in a plurality of memories provided in each of a plurality of computers.

### SUPPLEMENTARY INFORMATION A

The present disclosure includes the techniques described in the following supplementary notes. However, the present invention is not limited to the techniques described in the following supplementary notes, and various modifications can be made within the scope described in the claims.

### Supplementary Note A1

An information processing device, including:
an acquisition means for acquiring one or more models;
a selection means for selecting any action from among a plurality of candidate actions each defining a model improvement method; and
a generation means for generating an improved model from the one or more models by executing a selected action.

### Supplementary Note A2

The information processing device according to Supplementary Note A1, in which the selection means selects any one of the plurality of candidate actions with reference to a policy or information obtained by the policy.

### Supplementary Note A3

The information processing device according to Supplementary Note A2, in which
the policy includes a learned language model, and
the selection means selects any one of the plurality of candidate actions with reference to an output of the language model.

### Supplementary Note A4

The information processing device according to any one of Supplementary Notes A1 to A3,
in which the action executed by the generation means includes:
processing of generating data using at least one of the models by inputting a prompt to at least one of the one or more models; and
processing of updating at least one of the one or more models with reference to the generated data.

### Supplementary Note A5

The information processing device according to any one of Supplementary Notes A1 to A4, in which the action executed by the generation means includes processing of merging the one or more models.

### Supplementary Note A6

The information processing device according to any one of Supplementary Notes A1 to A5, in which the one or more models include a language model.

### Supplementary Note A7

The information processing device according to Supplementary Note A2 or A3, including:
an evaluation means for evaluating the improved model generated by the generation means; and
an update means for updating the policy or information referred to by the policy with reference to an evaluation result by the evaluation means.

### Supplementary Note A8

The information processing device according to Supplementary Note A7, in which
the evaluation result by the evaluation means includes a reward according to at least one of:
an index indicating accuracy of the improved model; and
a cost of computation to generate the improved model, and
the update means refers to the reward and updates the policy or information referred to by the policy.

### SUPPLEMENTARY INFORMATION B

The present disclosure includes the techniques described in the following supplementary notes. However, the present invention is not limited to the techniques described in the following supplementary notes, and various modifications can be made within the scope described in the claims.

### Supplementary Note B1

An information processing method, including:
acquisition processing of acquiring, by at least one processor, one or more models;
selection processing of selecting, by the at least one processor, any action from among a plurality of candidate actions each defining a model improvement method; and
generation processing of generating, by the at least one processor, an improved model from the one or more models by executing a selected action.

### Supplementary Note B2

The information processing method according to Supplementary Note B1, in which in
the selection processing the at least one processor selects any action from among the plurality of candidate actions with reference to a policy or information obtained by the policy.

### Supplementary Note B3

The information processing method according to Supplementary Note B2, in which
the policy includes a learned language model, and
in the selection processing, the at least one processor selects any one of the plurality of candidate actions with reference to an output of the language model.

### Supplementary Note B4

The information processing method according to any one of Supplementary Notes B1 to B3, in which
the action executed by the generation processing includes:
processing of generating, by the at least one processor, data using at least one of the models by inputting a prompt to at least one of the one or more models; and
processing of updating, by the at least one processor, at least one of the one or more models with reference to the generated data.

### Supplementary Note B5

The information processing method according to any one of Supplementary Notes B1 to B4, in which the action executed by the generation processing includes processing of merging, by the at least one processor, the one or more models.

### Supplementary Note B6

The information processing method according to any one of Supplementary Notes B1 to B5, in which the one or more models include a language model.

### Supplementary Note B7

The information processing method according to Supplementary Note B2 or B3,including:
evaluation processing of evaluating, by the at least one processor, the improved model generated in the generation processing; and
update processing of updating, by the at least one processor, the policy or information referred to by the policy with reference to an evaluation result by the evaluation processing.

### Supplementary Note B8

The information processing method according to Supplementary Note B7, in which
the evaluation result by the evaluation processing includes a reward according to at least one of:
an index indicating accuracy of the improved model; and
a cost of computation to generate the improved model, and
in the update processing, the at least one processor updates the policy or information referred to by the policy with reference to the reward.

### SUPPLEMENTARY INFORMATION C

The present disclosure includes the techniques described in the following supplementary notes. However, the present invention is not limited to the techniques described in the following supplementary notes, and various modifications can be made within the scope described in the claims.

### Supplementary Note C1

An information processing program for causing a computer to function as an information processing device, the information processing program causing the computer to execute:
an acquisition means for acquiring one or more models;
a selection means for selecting any action from among a plurality of candidate actions each defining a model improvement method; and
a generation means for generating an improved model from the one or more models by executing a selected action.

### Supplementary Note C2

The information processing program according to Supplementary Note C1, in which the selection means selects any one of the plurality of candidate actions with reference to a policy or information obtained by the policy.

### Supplementary Note C3

The information processing program according to Supplementary Note C2, in which
the policy includes a learned language model, and
the selection means selects any one of the plurality of candidate actions with reference to an output of the language model.

### Supplementary Note C4

The information processing program according to any one of Supplementary Notes C1 to C3,
in which the action executed by the generation means includes:
processing of generating data using at least one of the models by inputting a prompt to at least one of the one or more models; and
processing of updating at least one of the one or more models with reference to the generated data.

### Supplementary Note C5

The information processing program according to any one of Supplementary Notes C1 to C4, in which the action executed by the generation means includes processing of merging the one or more models.

### Supplementary Note C6

The information processing program according to any one of Supplementary Notes C1 to C5, in which the one or more models include a language model.

### Supplementary Note C7

The information processing program according to Supplementary Note C2 or C3, in which the program causes the computer to function as:
an evaluation means for evaluating the improved model generated by the generation means; and
an update means for updating the policy or information referred to by the policy with reference to an evaluation result by the evaluation means.

### Supplementary Note C8

The information processing program according to Supplementary Note C7, in which
the evaluation result by the evaluation means includes a reward according to at least one of:
an index indicating accuracy of the improved model; and
a cost of computation to generate the improved model, and
the update means refers to the reward and updates the policy or information referred to by the policy.

### SUPPLEMENTARY INFORMATION D

The present disclosure includes the techniques described in the following supplementary notes. However, the present invention is not limited to the techniques described in the following supplementary notes, and various modifications can be made within the scope described in the claims.

### Supplementary Note D1

An information processing device, including:
at least one processor,
in which the at least one processor executes:
acquisition processing of acquiring one or more models;
selection processing of selecting any action from among a plurality of candidate actions each defining a model improvement method; and
generation processing of generating an improved model from the one or more models by executing a selected action.

The information processing device may further include a memory. The memory may store a program for causing the at least one processor to execute each of the processing.

### Supplementary Note D2

The information processing device according to Supplementary Note D1, in which in
the selection processing the at least one processor selects any action from among the plurality of candidate actions with reference to a policy or information obtained by the policy.

### Supplementary Note D3

The information processing device according to Supplementary Note D2, in which
the policy includes a learned language model, and
in the selection processing, the at least one processor selects any one of the plurality of candidate actions with reference to an output of the language model.

### Supplementary Note D4

The information processing device according to any one of Supplementary Notes D1 to D3,
in which the action executed by the generation processing includes:
processing of generating data using at least one of the models by inputting a prompt in at least one of the one or more models; and
processing of updating at least one of the one or more models with reference to the generated data.

### Supplementary Note D5

The information processing device according to any one of Supplementary Notes D1 to D4, in which the action executed by the generation processing includes processing of merging the one or more models.

### Supplementary Note D6

The information processing device according to any one of Supplementary Notes D1 to D5, in which the one or more models include a language model.

### Supplementary Note D7

The information processing device according to Supplementary Note D2 or D3, in which the at least one processor executes:
evaluation processing of evaluating the improved model generated in the generation processing; and
update processing of updating the policy or information referred to by the policy with reference to an evaluation result by the evaluation processing.

### Supplementary Note D8

The information processing device according to Supplementary Note D7, in which
the evaluation result by the evaluation processing includes a reward according to at least one of:
an index indicating accuracy of the improved model; and
a cost of computation to generate the improved model, and
in the update processing, the at least one processor updates the policy or information referred to by the policy with reference to the reward.

### SUPPLEMENTARY INFORMATION E

The present disclosure includes the techniques described in the following supplementary notes. However, the present invention is not limited to the techniques described in the following supplementary notes, and various modifications can be made within the scope described in the claims.

### Supplementary Note E1

A non-transitory recording medium having recorded therein an information processing program for causing a computer to function as an information processing device, in which the computer is caused to execute:
acquisition processing of acquiring one or more models;
selection processing of selecting any action from among a plurality of candidate actions each defining a model improvement method; and
generation processing of generating an improved model from the one or more models by executing a selected action.

1. An information processing device, comprising:
at least one memory storing instructions, and
at least one processor configured to execute the instructions to:
acquire one or more models;
select any action from among a plurality of candidate actions each defining a model improvement method; and
generate an improved model from the one or more models by executing a selected action.

2. The information processing device according to claim 1, wherein the at least one processor is further configured to execute the instructions to select any one of the plurality of candidate actions with reference to a policy or information obtained by the policy.

3. The information processing device according to claim 2, wherein
the policy includes a learned language model, and
the at least one processor is further configured to execute the instructions to select any one of the plurality of candidate actions with reference to an output of the language model.

4. The information processing device according to claim 1, wherein generating the improved model includes:
generating data using at least one of the models by inputting a prompt to at least one of the one or more models; and
updating at least one of the one or more models with reference to the generated data.

5. The information processing device according to claim 1, wherein generating the improved model includes processing of merging the one or more models.

6. The information processing device according to claim 1, wherein the one or more models include a language model.

7. The information processing device according to claim 2, wherein the at least one processor is further configured to execute the instructions to:
evaluate the generated improved model; and
update the policy or information referred to by the policy with reference to an evaluation result.

8. The information processing device according to claim 7, wherein
the evaluation result includes a reward according to at least one of:
an index indicating accuracy of the improved model; and
a cost of computation to generate the improved model, and
the at least one processor is further configured to execute the instructions to refer to the reward and update the policy or information referred to by the policy.

9. An information processing method, comprising:
acquiring, by at least one processor, one or more models;
selecting, by the at least one processor, any action from among a plurality of candidate actions each defining a model improvement method; and
generating, by the at least one processor, an improved model from the one or more models by executing a selected action.

10. The information processing method according to claim 9, wherein the at least one processor selects any action from among the plurality of candidate actions with reference to a policy or information obtained by the policy.

11. The information processing method according to claim 10, wherein
the policy includes a learned language model, and
the at least one processor selects any one of the plurality of candidate actions with reference to an output of the language model.

12. The information processing method according to claim 9, wherein
generating the improved model includes:
generating, by the at least one processor, data using at least one of the models by inputting a prompt to at least one of the one or more models; and
updating, by the at least one processor, at least one of the one or more models with reference to the generated data.

13. The information processing method according to claim 9, wherein generating the improved model includes merging, by the at least one processor, the one or more models.

14. The information processing method according to claim 9, wherein the one or more models include a language model.

15. The information processing method according to claim 10, comprising:
evaluating, by the at least one processor, the improved model generated in the generation processing; and
updating, by the at least one processor, the policy or information referred to by the policy with reference to an evaluation result by the evaluation processing.

16. The information processing method according to claim 15, wherein
the evaluation result includes a reward according to at least one of:
an index indicating accuracy of the improved model; and
a cost of computation to generate the improved model, and
the at least one processor updates the policy or information referred to by the policy with reference to the reward.

17. A non-transitory computer readable medium storing an information processing program for causing a computer to function as an information processing device, the information processing program causing the computer to execute:
acquiring one or more models;
selecting any action from among a plurality of candidate actions each defining a model improvement method; and
generating an improved model from the one or more models by executing a selected action.

18. The non-transitory computer readable medium storing the information processing program according to claim 17, wherein the information processing program causing the computer to execute selecting any one of the plurality of candidate actions with reference to a policy or information obtained by the policy.

19. The non-transitory computer readable medium storing the information processing program according to claim 18, wherein
the policy includes a learned language model, and
the information processing program causing the computer to execute selecting any one of the plurality of candidate actions with reference to an output of the language model.

20. The non-transitory computer readable medium storing the information processing program according to claim 17, wherein
generating the improved model includes:
generating data using at least one of the models by inputting a prompt to at least one of the one or more models; and
updating at least one of the one or more models with reference to the generated data.
